(19) United States
(12) Patent Application Publication
(10) Pub. No.: US 2025/0373967 A1
(43) Pub. Date: Dec. 4, 2025

(54) Hearing Accessory for Wearable Devices

(71) Applicant: Apple Inc., Cupertino, CA (US)

(72) Inventors: Jarrett B. Lagler, San Francisco, CA (US); Esge B. Andersen, Campbell, CA (US); Michael C. Friedman, Nederland, CO (US); David M. Tremblay, Boulder, CO (US); Scott P. Porter, San Jose, CA (US)

(21) Appl. No.: 19/098,532

(22) Filed: Apr. 2, 2025

Related U.S. Application Data
(60) Provisional application No. 63/655,499, filed on Jun. 3, 2024.

(51) Int. Cl. H04R 1/02

(52) U.S. Cl. CPC H04R 1/025

(57) ABSTRACT

A wearable device hearing accessory comprising: an attachment portion configured to attach to an output port of an extra-aural audio unit of a wearable device; a compliant guide portion configured to extend from the attachment portion to an ear of a user and transmit a sound wave to the ear; and a sensor operable to detect a coupling or decoupling of the attachment portion to the extra-aural audio unit.

### CROSS-REFERENCE TO RELATED APPLICATION

This application is a non-provisional application of co-pending U.S. Provisional Patent Application No. 63/655,499, filed Jun. 3 2024, and incorporated herein by reference.

### FIELD

An aspect of the disclosure is directed to a hearing accessory for a wearable device, more specifically a passive or active hearing accessory for transmission of sound from a wearable device to an ear of a user. Other aspects are also described and claimed.

### BACKGROUND

Extra-aural speakers associated with a wearable device have inherent performance tradeoffs compared to headphones. For example, in the case of a head mounted wearable device, the speaker unit may be mounted on or to a portion of the device that is positioned on or near the ear when the device is on the user's head. Thus, while the user can hear the sound output by the speaker unit near their ear, sound quality, loudness and user privacy and/or speaker efficiency may suffer as compared to when the sound is output directly into the ear, such as by a headphone on or in the ear.

### SUMMARY

An aspect of the disclosure is directed to an acoustic or audio accessory that guides audio or sound emitted from a wearable device into a user's ear when, for example, the user wants privacy or better sound quality. Representatively, the wearable device may be a head-mounted or worn device. In some aspects, the head-mounted or worn device may be smart glasses or spectacles. In other aspects, the head-mounted or worn device may be a mixed reality unit that combines both augmented and virtual realities. In aspects where the wearable device is smart glasses or spectacles, the glasses may include, among other aspects, a frame including a front part that holds the lenses and temples or arms that extend from the front part over the user's ears. In other aspects, the device may include a display enclosed within a housing configured to rest on the user's face and contain various components for displaying stereoscopic images to the user, such as screens, lenses, sensors and/or audio components, and a band or a strap that connects to the display and encircles the head to hold or mount the display in position over the users eyes. An extra-aural speaker unit or pod that emits audio or sound to the ambient environment may also be mounted or otherwise coupled to a portion of the frame or band. For example, in some aspects, the speaker unit or pod may be coupled to a band or one or more of the temples or arms such that the speaker is near the ear and the emitted audio or sound can be heard by the ear. When, however, privacy or improved audio quality is desired, the acoustic or audio accessory may be coupled to the speaker and configured to guide or direct the audio directly to the ear in one mode. For example, in some aspects, the audio accessory may be a passive audio accessory including a tube that can connect to the speaker at one end and be inserted into the ear at the other end in the privacy mode. When an open air or baseline operating mode is desired, the user may remove the tube from the speaker and the glasses may operate in a public mode. The glasses may sense or otherwise detect when the tube is attached and when the tube is not attached to transition between the privacy mode and the public mode, and adjust or tune the acoustic output accordingly. In some aspects, the tube(s) may have a preconfigured length. In this aspect, when the tube is attached to the speaker, the digital signal processing function associated with the glasses can automatically detect the type of tube and compensate for frequency response to the tube in real time. The tube can be replaceable and flexible so that it is comfortable to the user. In other aspects, the audio accessory may be an active audio accessory. Representatively, the audio accessory may be made up of a wire providing an electrical connection from the glasses to an end that is inserted into the ear and configured to output the sound into the ear. For example, the active audio accessory may include a speaker at the end inserted into the ear. The speaker at the end of the wire may work with the speaker coupled to the wearable device, or in some aspects, may replace the speaker coupled to the band, temple or arm of the wearable device. In other aspects, a microphone may further be connected to the end of the wire to enable an active noise cancellation (ANC) functionality. In addition, in still further aspects, the active audio accessory may include a tube as previously discussed to direct sound to the ear and a microphone at the end of a wire coupled to the tube inserted into the ear for ANC functionality. The processors and batteries of the wearable device may be leveraged to enable the use of additional speakers, a microphone, the tuning and/or ANC functionalities.

In some aspects, the disclosure is directed to a wearable device hearing accessory comprising: an attachment portion configured to attach to an output port of an extra-aural audio unit of a wearable device; a compliant guide portion configured to extend from the attachment portion to an ear of a user and transmit a sound wave to the ear; and a sensor operable to detect a coupling or decoupling of the attachment portion to the extra-aural audio unit. In some aspects, the extra-aural audio unit is a speaker and the output port is a first output port, the speaker further comprises a second output port, and the attachment portion is configured to close the second output port when attached to the speaker. In other aspects, the second output port is a vent port from a back volume chamber of the speaker. In still further aspects, the compliant guide portion comprises a tube that passively guides a sound wave emitted by the extra-aural audio unit from the output port to a sound output opening at an end of the tube. In some aspects, the compliant guide portion further comprises a wire configured to transmit an audio signal from a microphone electrically coupled to an end of the wire to enable an active noise cancellation function. In still further aspects, the compliant guide portion comprises a wire having a first end fixedly coupled to the attachment portion and a second end electrically coupled to a speaker that is operable to output sound to the ear. In some aspects, the extra-aural audio unit is disabled from outputting sound when the speaker outputs sound to the ear. In some aspects, a microphone is coupled to an end the compliant guide portion positioned in the ear, and the microphone is configured to pick-up noise near the ear to enable an active noise cancellation function. In some aspects, the sensor may be a proximity sensor coupled to the wearable device. In other aspects, the wearable device may include a wearable device having a display connected to a band that extends over an ear of the user, and the extra-aural audio unit is mounted to the band.

In other aspects, a wearable device hearing accessory system includes a hearing assembly comprising an attachment portion configured to attach to an extra-aural audio unit of a wearable device, a compliant guide portion configured to extend from the attachment portion to an ear of a user and transmit a sound wave to the ear, and a sensor operable to detect a mode of the wearable device; and one or more processors communicatively coupled to the wearable device and operable to tune the sound wave based on the mode of the wearable device. The hearing assembly may include a passive hearing assembly that passively guides the sound wave through the compliant guide portion to the ear. In other aspects, the hearing assembly may include an active hearing assembly that electrically transmits an audio signal to a speaker coupled to an end of the compliant guide portion positioned in the ear. In some aspects, the mode of the wearable device detected by the sensor is an accessory mode in which the hearing assembly is attached to the wearable device. In some aspects, when in the accessory mode, the sound wave is tuned to compensate for a characteristic of the compliant guide portion. In some aspects, the characteristic of the compliant guide portion is a length of the compliant guide portion. In still further aspects, in the accessory mode, a second output port from a back volume chamber of the extra-aural audio unit is closed. In some aspects, a microphone is coupled to an end of the compliant guide portion positioned near the ear of the user, and the one or more processors are further operable to activate an active noise cancellation function based on detection of a noise near the ear. In other aspects, the mode of the wearable device detected by the sensor is a non-accessory mode in which the hearing assembly is detached from the wearable device. In some aspects, in the non-accessory mode, the sound wave is tuned to optimize transmission of the sound wave through open air to the ear.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect in this disclosure are not necessarily to the same aspect, and they mean at least one.

FIG. 1 illustrates a side perspective view of a user wearing a wearable device including an audio hearing accessory.

FIG. 2 illustrates another aspect of a side perspective view of an audio hearing accessory.

FIG. 3 illustrates another aspect of a side perspective view of an audio hearing accessory.

FIG. 4 illustrates another aspect of a side perspective view of an audio hearing accessory.

FIG. 5 illustrates another aspect of a side perspective view of an audio hearing accessory.

FIG. 6 illustrates a block diagram of one representative process flow for using the audio hearing accessory.

FIG. 7 illustrates a block diagram of an example system of a wearable device including the audio hearing accessory.

### DETAILED DESCRIPTION

In this section we shall explain several preferred aspects of this disclosure with reference to the appended drawings. Whenever the shapes, relative positions and other aspects of the parts described are not clearly defined, the scope of the disclosure is not limited only to the parts shown, which are meant merely for the purpose of illustration. Also, while numerous details are set forth, it is understood that some aspects of the disclosure may be practiced without these details. In other instances, well-known structures and techniques have not been shown in detail so as not to obscure the understanding of this description.

The terminology used herein is for the purpose of describing particular aspects only and is not intended to be limiting of the disclosure. Spatially relative terms, such as “beneath”, “below”, “lower”, “above”, “upper”, and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a” “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

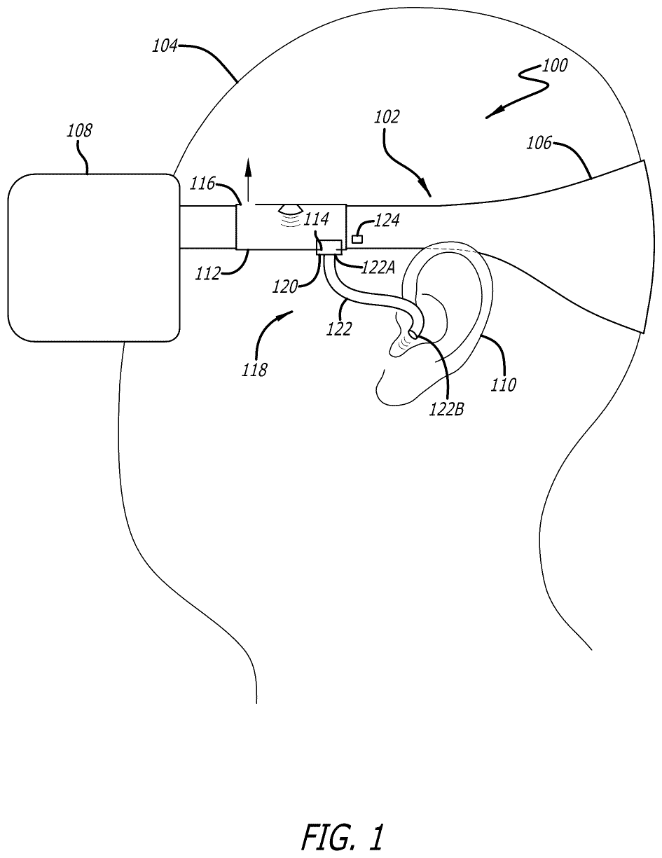

FIG. 1 illustrates a side perspective view of a user wearing a wearable device assembly or system including a wearable device and an acoustic or audio accessory.

Representatively, as can be seen from this view, wearable device assembly 100 includes a wearable device 102 worn on the user's head 104. For example, wearable device 102 may, in some aspects, be a pair of smart glasses or spectacles including a frame having a lens or display portion 108 and a portion 106 that extends from the lens or display portion 108 over the user's ear 110 and/or around the user's head. In some aspects, portion 106 may be a band that may include an arm portion of a pair of smart glasses or spectacles that rests on the user's ear or a strap that goes around the user's head. Lens or display portion 108 is positioned over the user's eyes when portion 106 is positioned over the ear 110 as shown. In some aspects, the lens or display portion 108 may include smart lenses or an otherwise smart display portion that will allow for an augmented reality, virtual reality, mixed reality or other immersive or smart experience when positioned over the user's eyes. An audio or acoustic pod or unit 112 including one or more audio or sound output ports 114, 116 may further be mounted to device 102 to output or emit a sound or sound pressure waves that enhances the visual effects displayed by lens or display portion 108 to the user's ear 110. For example, in some aspects, audio or acoustic pod or unit 112 may be an extra-aural speaker pod that is mounted to, within or otherwise on portion 106 near the user's ear 110. The acoustic or speaker pod 112 may be configured to output or otherwise emit a sound from a front volume of the speaker through a speaker port 114 near the user's ear 110 that corresponds to, for example, images or other smart experiences being output or displayed by lens or display portion 108. Acoustic pod or unit 112 may, in some aspects, further include a back output port 116 from a back volume of the speaker pod or unit 112 to the ambient environment that in some aspects may further enhance the acoustic experience. For example, back output port 116 may be a leak port or pressure equalization port that vents sound or pressure from the speaker back volume as illustrated by the arrow.

To further enhance the experience, a hearing, acoustic or audio assembly or accessory 118 may be removably connected, attached or mounted to audio pod 112, or another suitable portion of the wearable device near the user's ear 110. Audio accessory 118 may be a hearing accessory configured to direct or guide the sound waves emitted from speaker port 114 directly to the user's ear 110 when it is attached to audio pod 112 and/or wearable device 102. In some aspects, audio accessory 118 may be considered or referred to herein as a passive audio accessory or a passive audio waveguide in configurations in which it has a shape, size and/or structure selected to passively guide sound waves directly to ear 110. In other aspects, audio accessory 118 may be considered or referred to herein as an active audio accessory in configurations in which it includes electrical or electronic components that actively transmit audio or sound signals directly to ear 110. FIG. 1 illustrates a passive acoustic or audio accessory 118 including an attachment portion 120 that attaches audio accessory 118 to audio pod 112, and a guide portion 122 that passively guides the sound waves from audio pod 112 to the ear 110. In this aspect, attachment portion 120 may be any type of attachment mechanism that is able to connect and align guide portion 122 with speaker port 114. For example, in some aspects, attachment portion 120 may be a mechanical connection mechanism that latches, clips, clamps or otherwise attaches to audio pod 112 directly, or portion 106 near audio pod 112 so that attachment portion 120 covers speaker port 114. In other aspects, attachment portion 120 could have a magnet that is attracted to a magnet or metallic feature in audio pod 112 and/or portion 106 to align and hold (or attach) the attachment portion 120 to pod 112 and/or portion 106. Any other suitable mechanism that allows a user to easily and securely couple and/or uncouple attachment portion 120 with pod 112 and/or portion 106, however, is contemplated. In this aspect, for example, when a more private listening experience is desired, the user may manually attach attachment portion 120 to pod 112 and/or band or arm portion 106. When a more open experience is desired, the user may manually detach attachment portion 120 from pod 112 and/or band or arm portion 106.

Referring now in more detail to guide portion 122, guide portion 122 may in some aspects be a hollow tube, pathway, channel or the like that extends from a first open end 122A that is fixedly coupled to attachment portion 120 to a second open end 122B. Guide portion 122 may, in some aspects, be made of a compliant or flexible material that the user can bend or otherwise manipulate so that second open end 122B comfortably rests within ear 110. Representatively, guide portion 122 may be a compliant or flexible tube made of a compliant or flexible polymeric material such as a plastic or another flexible material suitable for transmitting sound. For example, in some aspects, first open end 122A is connected to attachment portion 120 as previously discussed, and second open end 122B is positioned within or near an ear canal of ear 110. Guide portion 122 may be bent or curved, for example around or over the front of the ear, so that second open end 122B reaches and sits within ear 110, for example, within or near the ear canal. In this aspect, the sound waves output by speaker pod 112 travel through guide portion 122 and out second open end 122B directly to ear 110. In this aspect, second open end 122B may be sized and shaped to fit within ear 110, and in some aspects within the ear canal of ear 110. Guide portion 122 may also have a particular interior size (e.g., diameter), shape (e.g., round, polygonal, etc.) and/or length selected for optimal sound transmission to ear 110. Representatively, in some aspects, a length of guide portion 122 may be specially selected so that it can extend comfortably from wearable device band or arm 106 and/or speaker pod 112 to ear 110 and also to achieve a desired acoustic output. For example, guide portion 122 may have a length that allows for some bend and accommodates different distances from wearable device arm or band 106 and/or speaker pod 112 to the ear depending on the size of the user's head, but should not be so long that it puckers or otherwise protrudes out from the user's face such that it could be caught on something or pulled away from the ear 110. Representatively, in some aspects, guide portion 122 may have a length that is at least equal to a distance between speaker pod 112 and the ear canal of ear 110 but less than about four inches, less than about three inches, or less than about two inches.

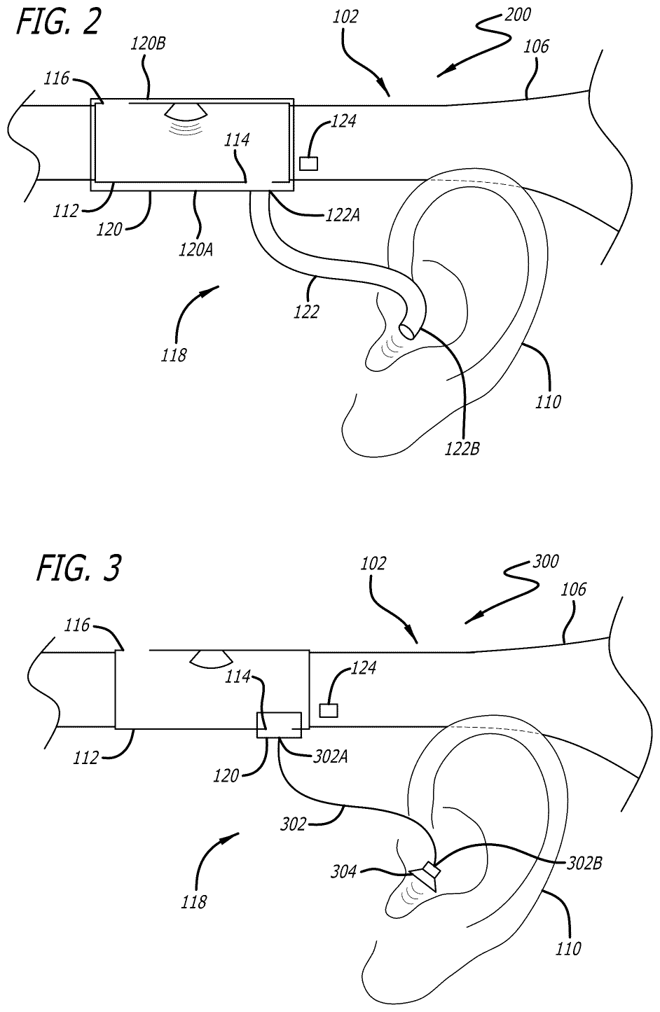

As previously discussed, when guide portion 122 is attached to speaker pod 112 by attachment portion 120, instead of transmitting sound from speaker pod 110 to the ambient environment, the sound is transmitted directly to ear 110 through guide portion 122. In this aspect, in addition to a better acoustic experience, the user may benefit from a more private experience in which people around them can no longer hear the sound output by speaker pod 112. Moreover, when accessory 118 is coupled to speaker pod 110, it may be desirable to tune the speaker to output sound differently than when accessory 118 is not present. In this aspect, the speaker pod 112, or the assembly or system in general, may be considered to have an accessory, privacy or closed air mode (e.g., accessory 118 is coupled to port 114), and a non-accessory, non-privacy or open air mode (accessory 118 is not coupled to port 114). In the accessory, privacy or closed air mode, the sound output by speaker pod 112 may be tuned (e.g., a sound loudness or decibel level may be reduced) to optimize the sound quality and/or privacy aspects of the sound being transmitted through guide portion 122. In the non-accessory, non-privacy or open air mode, the speaker pod 110 may be untuned or tuned differently (e.g., a sound loudness or decibel level may be increased) to optimize the sound quality reaching the ear 110 through the open air. In still further aspects, depending on the mode, it may be desirable to open or close the leak port 116. For example, in some aspects, it may be desirable to close leak port 116 when in the accessory, privacy or closed air mode for optimal privacy. One representative mechanism for closing or opening leak port 116 will be described in further detail in reference to FIG. 2.

In some aspects, wearable device assembly 100 may be configured to automatically detect whether or not the accessory 118 is coupled to wearable device 102 and the system is therefore in an accessory, privacy or closed air mode, or a non-accessory, non-privacy or open air mode. Representatively, in some aspects, wearable device assembly 100 may further include a sensor 124 that detects the presence or absence of accessory 118. For example, sensor 124 could be a proximity sensor attached to portion 106 as shown. Sensor 124 may emit an electromagnetic field or beam of electromagnetic radiation toward speaker pod 112 and detect changes in the field or return signal due to the accessory 118 being attached to speaker pod 112 or portion 106 near speaker pod 112. Other types of sensors or sensor mechanism are, however, contemplated. For example, sensor 124 may be a hall effect sensor, a capacitive sensor, a radio-frequency identification (RFID) type sensor, or may be an acoustic sensor which detects a change in acoustic impedance to determine the presence or absence of the accessory. When sensor 124 detects the presence of accessory 118, the system may be configured to transition to the accessory, privacy or closed air mode, and activate or otherwise engage in additional tuning or adaptive algorithm functions to tune or otherwise enhance the audio output by speaker pod 112 through the accessory 118 to the user's ear 110. On the other hand, when sensor 124 does not detect the presence of accessory 118, the system may be configured to transition to the non-accessory, non-privacy or open air mode, and either not activate or otherwise disengage from any additional tuning of the audio output, or tune the audio output in a way that enhances the sound output through the ambient environment to the user's ear 110. In addition, in some aspects, sensor 124 may also detect a characteristic of accessory 118 that may be taken into account when engaging the tuning function. For example, sensor 124 may detect the length of guide portion 122 and the tuning function may tune the audio signal based on the detected length. For example, the distance between the audio pod 112 and the user's ear may vary depending on the user, therefore the length of guide portion 122 may also vary. The tuning may therefore be adjusted depending on the length of guide portion 122 used by a particular person. Alternatively, this information could be preprogrammed into the system by the user. For example, a reading of the accessory, and guide portion 122 length specifically, may be taken and imported into the software which then uses this information for frequency compensation and/or tuning. It should further be understood that while sensor 124 is shown coupled to wearable device 102, sensor 124 could be coupled to audio accessory 118, for example, attachment portion 120, or may include a sensor assembly including components coupled to both wearable device 102 and accessory 118.

Referring now to FIG. 2, FIG. 2. illustrates a wearable device assembly 200 including an audio or speaker pod 112 coupled to wearable device 102 as previously discussed in reference to FIG. 1. An acoustic or audio assembly or accessory 118 similar to the audio accessory previously discussed in reference to FIG. 1 is further shown connected, attached or mounted to audio pod 112. Accessory 118 includes the same components as the accessory 118 described in reference to FIG. 1, however, in this configuration, accessory 118 is configured to cover or close back output port 116. Representatively, as previously discussed, when accessory 118 is coupled to wearable device 102 such that it is in an accessory, closed air, or privacy mode, it may be desirable to close port 116 from the speaker back volume. Therefore, in this configuration, attachment portion 120 is configured to align and couple guide portion 122 of accessory 118 to port 114, while also closing port 116. For example, in this configuration, attachment portion 120 may be an elongated structure that includes a first portion 120A that extends over port 114 and aligns guide portion 122 with port 114. Attachment portion 120 may further include a second portion 120B that extends over port 116 and closes port 116 to prevent the output of sound and/or pressure through port 116. Representatively, in some aspects, attachment portion 120 may be a tube or other similar elongated structure having portions 120A, 120B that can be slid or otherwise moved over or around the wearable device portion 106 to speaker pod 112 to attach to speaker pod 112 such that portion 120B covers (i.e., closes) port 116 as discussed. It should further be understood that other mechanisms may be used in addition to or instead of attachment portion 120 to close port 116. Representatively, in other configurations, a valve or other similar mechanism suitable for opening/closing a port may be coupled to speaker pod 112 and/or port 116. The valve or other similar mechanism may be configured to automatically open or close the port when the system detects the presence of accessory 118 and therefore it is desirable to have port 116 closed, as previously discussed.

Referring now to FIG. 3, FIG. 3. illustrates a wearable device assembly 300 including an audio or speaker pod 112 coupled to wearable device 102 as previously discussed in reference to FIG. 1. An acoustic or audio assembly or accessory 118 similar to the audio accessory previously discussed in reference to FIG. 1 is further shown connected, attached or mounted to audio pod 112. Accessory 118 performs a similar function of transmitting audio directly from speaker pod 112 to ear 110 as previously discussed, except that in this configuration, audio accessory 118 is an active audio accessory. Representatively, in this configuration, audio accessory 118 may include the attachment portion 120 as described in reference to FIG. 1. Guide portion 302, however, is a wire, cord, cable or other similar audio connector configured to electrically transmit or otherwise guide an audio signal from wearable device 102 and/or speaker pod 112 to a speaker 304 coupled to the second end 302B of guide portion 302 positioned within ear 110. Representatively, attachment portion 120 may be used to electrically connect a first end 302A of guide portion 302 to an amplifier that is already associated with wearable device 102 and/or speaker pod 112 to output an electrical audio signal to the speaker pod 112. The second end 302B of guide portion 302 is connected to speaker 304, which receives the audio signal and converts it to sound waves that are output directly to ear 110. In some aspects, speaker 304 may operate in addition to speaker pod 112 to output the desired sound to the user's ear 100. In other aspects, speaker 304 may be used instead of speaker pod 112 to output the desired sound to the user's ear 110. For example, when the system detects that accessory 118 is attached to wearable device 102, speaker pod 112 may be disabled and speaker 304 may instead receive the audio signal and output the sound that would have otherwise been output by speaker pod 112 to ear 110. In still further aspects, it is contemplated that in some aspects the speaker pod 112 may be omitted entirely, and speaker 304 of accessory 118 is the only speaker used to output sound from wearable device 102 to ear 110.

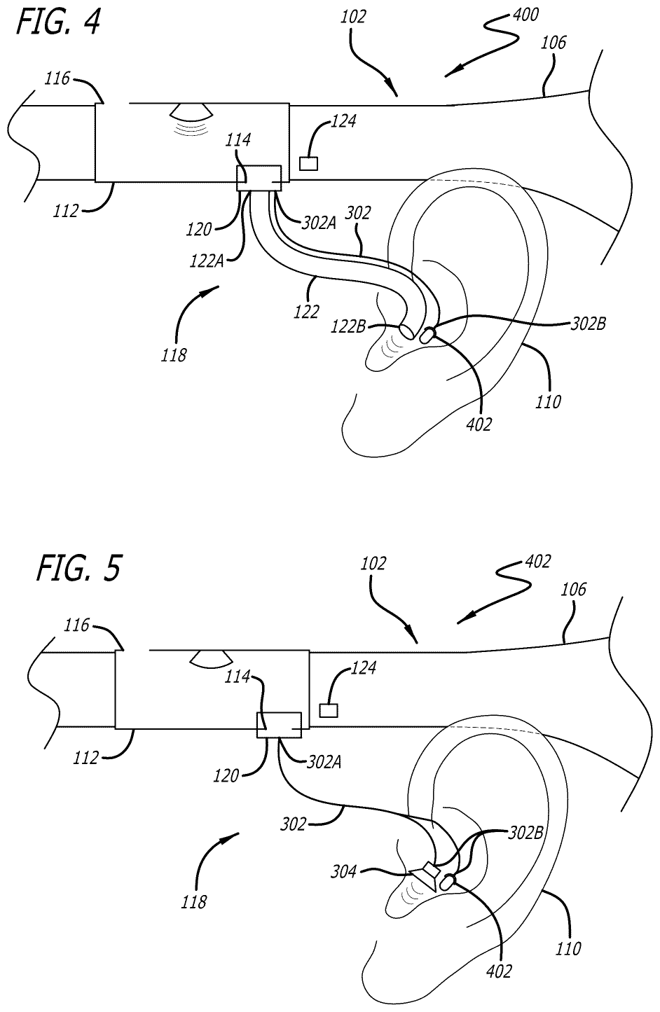

Referring now to FIG. 4, FIG. 4. illustrates a wearable device assembly 400 including an audio or speaker pod 112 coupled to wearable device 102 as previously discussed in reference to FIG. 1. An acoustic or audio assembly or accessory 118 similar to the audio accessory previously discussed in reference to FIG. 1 is further shown connected, attached or mounted to audio pod 112. Accessory 118 performs a similar function of transmitting audio directly from speaker pod 112 to ear 110 as previously discussed, except that in this configuration, audio accessory 118 is a hybrid passive and active audio accessory. Representatively, in this configuration, audio accessory 118 may include the attachment portion 120 and guide portion 122 as described in reference to FIG. 1. Guide portion 122 may be a hollow tube or other similar structure operable to guide a sound emitted from port 114 of speaker pod 112 to ear 110 as previously discussed. A further guide portion 302 similar to that described in reference to FIG. 3 may also be provided to electrically transmit or otherwise guide an audio signal from a microphone 402 coupled to the second end 302B of guide portion 302 positioned within ear 110. For example, guide portion 302 may be a wire, cord, cable or other similar audio connector configured to electrically transmit or otherwise guide an audio signal from microphone 402 to wearable device 102 for processing of the signal, and in some cases, activation of an active noise cancellation (ANC) function. Representatively, microphone 402 may be configured to pick-up sounds or noise near the user's ear 110. For example, when ambient noise or sound is detected by microphone 402 near ear 110, a processor associated with the system or assembly may activate an active noise cancellation (ANC) function that causes a system speaker to produce anti-noise that reduces the ambient noise leaking into ear 110 from the ambient environment for an improved acoustic experience. In some aspects, guide portion 122 and guide portion 302 may be coupled to one another. For example, guide portion 302 may be a wire attached to an inner surface, an outer surface or embedded within a wall of a flexible tube forming guide portion 122. In this aspect, the positioning of guide portion 122 within ear 110 also positions guide portion 302 and the microphone 402 within the ear 110. In addition, similar to the previously discussed configurations, wearable assembly 400 may be configured to detect (e.g., using sensor 124) whether or not accessory 118 is attached or otherwise coupled to wearable device 102, and in turn whether device 102 is in accessory or non-accessory mode, so that it may automatically tune the acoustic output of speaker pod 112 accordingly.

Referring now to FIG. 5, FIG. 5. illustrates a wearable device assembly 100 including an audio or speaker pod 112 coupled to wearable device 102 as previously discussed in reference to FIG. 1. An acoustic or audio assembly or accessory 118 similar to the audio accessory previously discussed in reference to FIG. 1 is further shown connected, attached or mounted to audio pod 112. Accessory 118 performs a similar function of transmitting audio directly from speaker pod 112 to ear 110 as previously discussed, except that in this configuration, audio accessory 118 is an active audio accessory. Representatively, in this configuration, audio accessory 118 may include the attachment portion 120 as described in reference to FIG. 1. Guide portion 302, however, is made up of one or more of a wire, cord, cable or other similar audio connector configured to electrically transmit or otherwise guide an audio signal between wearable device 102 and/or speaker pod 112, and a speaker 304 and microphone 402 coupled to the second end 302B of guide portion 302 positioned within ear 110. Representatively, attachment portion 120 may be used to electrically connect a first end 302A of guide portion 302 to an amplifier that is already associated with wearable device 102 and/or speaker pod 112 to output an electrical audio signal to the speaker pod 112. The second end 302B of guide portion 302 is connected to speaker 304, which receives the audio signal and converts it to sound waves that are output directly to ear 110. In some aspects, speaker 304 may operate in addition to speaker pod 112 to output the desired sound to the user's ear 100, or instead of speaker pod 112 as previously discussed in reference to FIG. 3. In addition, in this configuration, a microphone 402 may further be connected to second end 302B of guide portion 302. Microphone 402 may be similar to the microphone described in reference to FIG. 4, and configured to pick-up sounds or noise near the user's ear 110. For example, when ambient noise or sound is detected by microphone 402 near ear 110, a processor associated with the system or assembly may activate an active noise cancellation (ANC) function that causes a system speaker to produce anti-noise that reduces the ambient noise leaking into ear 110 from the ambient environment for an improved acoustic experience. In some aspects, guide portion 302 may include more than one wire. For example, guide portion 302 may include a wire connected at one end to speaker 304 and a wire connected at one end to microphone 402, and the other ends of the wires may be connected to contacts of one or more amplifiers associated with speaker pod 112, or wearable device 102, for output, intake, and/or processing of the audio signals.

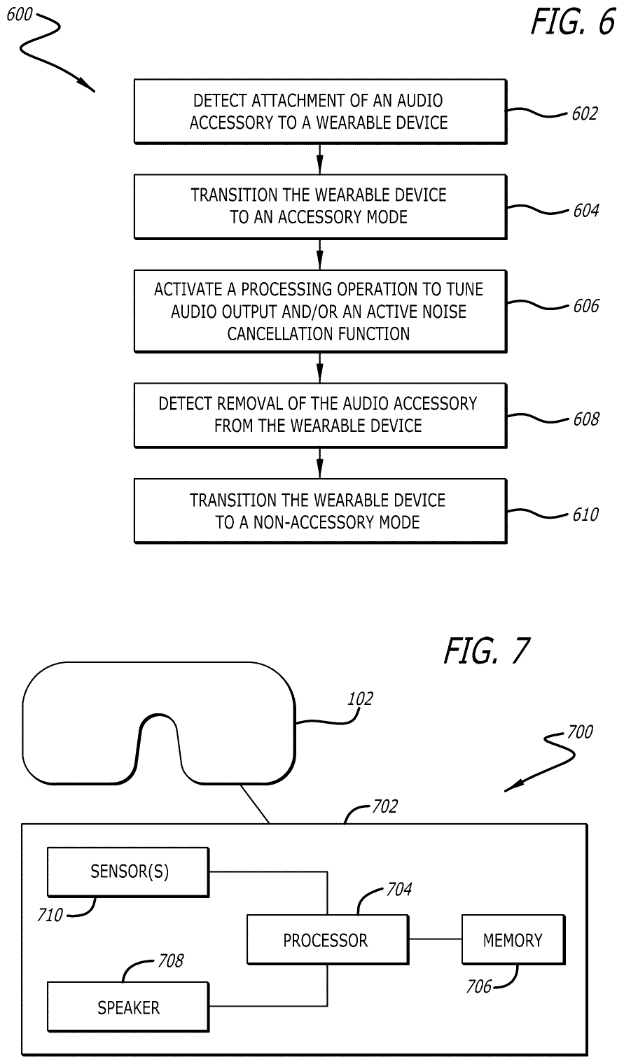

Referring now to FIG. 6, FIG. 6 illustrates a block diagram of one representative process flow for using the audio accessory. Process 600 may include an initial operation 602 of detecting attachment of a hearing accessory to a wearable device. For example, the attachment may be detected by one or more of a hall-effect sensor, proximity sensor or other electrical/mechanical sensor 124 that is coupled to wearable device 102 and/or audio pod 112 to detect attachment of audio accessory 118 to the device, as previously discussed in reference to FIGS. 1-5. Once the attachment of audio accessory to the wearable device and/or the audio pod is detected, the process continues to operation 604 in which the system transitions the wearable device to an accessory mode. Once in the accessory mode, the system may activate a processing operation to tune the audio output and/or an active noise cancellation (ANC) function at operation 606. For example, as previously discussed, in the accessory or privacy mode, the audio signals and/or speaker output may be tuned to account for the sound now being transmitted directly to the ear by the accessory, instead of through the ambient environment. For example, the sound output may be tuned based on a characteristic of the accessory, such as a length of the accessory guide portion (e.g., guide portion 122). In addition, in some aspects, in the accessory mode, a vent port of the speaker pod may be closed to optimize privacy and/or the acoustic output in the accessory mode. In still further aspects, when a microphone associated with the audio accessory picks up ambient noise near the ear, an ANC function may be activated. Process 600 may further include operation 608 in which the system detects removal or detachment of the audio accessory from the wearable device. Once the removal or detachment of audio accessory from the wearable device is detected, the process continues to operation 610 in which the system transitions the wearable device to a non-accessory or non-privacy mode. As previously discussed, in the non-accessory or non-privacy mode, the audio signals and/or speaker output may be tuned to account for the sound now being transmitted through the ambient environment to the ear, without the aid of the accessory. In addition, in some aspects, in the non-accessory mode, a vent port of the speaker pod may be opened to optimize the acoustic output in the non-accessory mode.

FIG. 7 illustrates a block diagram of an example system of a wearable device including the audio accessory. System 700 may include a wearable device 102 (e.g., smart glasses) as previously discussed in reference to FIG. 1. Wearable device 102 may further include a computing or electronic device 702, or otherwise be communicatively coupled to a computing or electronic device 702, that is operable to perform the various functions and/or processing operations described herein. For example, device 702 may include a processor 704 connected to a memory 706 that stores a software application or algorithm for tuning an acoustic output as previously discussed. For example, if one or more of sensors 710 detect that the audio accessory (e.g., accessory 118) is attached to the speaker and is on or near the ear of the user, processor 704 may initiate a digital signal processing function to tune the audio signal emitted by speaker 708 to achieve the desired acoustic output based on this information. In still further aspects where sensor 704 is a microphone that detects background or ambient noises near the user's ear as previously discussed, processor 704 may initiate noise cancellation, or other algorithms to improve the users audio experience.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. For example, although smart glasses are described herein as the exemplary wearable device, it is contemplated that the wearable device may be any number of devices worn on the head of a user and having extra-aural speakers, including but not limited to, an augmented or virtual reality headset, goggles, helmets, medical devices or the like. The description is thus to be regarded as illustrative instead of limiting. In addition, to aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A wearable device hearing accessory comprising:
an attachment portion configured to attach to an output port of an extra-aural audio unit of a wearable device;
a compliant guide portion configured to extend from the attachment portion to an ear of a user and transmit a sound wave to the ear; and
a sensor operable to detect a coupling or decoupling of the attachment portion to the extra-aural audio unit.

2. The hearing accessory of claim 1 wherein the extra-aural audio unit is a speaker and the output port is a first output port, the speaker further comprises a second output port, and the attachment portion is configured to close the second output port when attached to the speaker.

3. The hearing accessory of claim 2 wherein the second output port is a vent port from a back volume chamber of the speaker.

4. The hearing accessory of claim 1 wherein the compliant guide portion comprises a tube that passively guides a sound wave emitted by the extra-aural audio unit from the output port to a sound output opening at an end of the tube.

5. The hearing accessory of claim 4 wherein the compliant guide portion further comprises a wire configured to transmit an audio signal from a microphone electrically coupled to an end of the wire to enable an active noise cancellation function.

6. The hearing accessory of claim 1 wherein the compliant guide portion comprises a wire having a first end fixedly coupled to the attachment portion and a second end electrically coupled to a speaker that is operable to output sound to the ear.

7. The hearing accessory of claim 6 wherein the extra-aural audio unit is disabled from outputting sound when the speaker outputs sound to the ear.

8. The hearing accessory of claim 6 further comprising a microphone coupled to an end the compliant guide portion positioned in the ear, and the microphone is configured to pick-up noise near the ear to enable an active noise cancellation function.

9. The hearing accessory of claim 1 wherein the sensor comprises a proximity sensor coupled to the wearable device.

10. The hearing accessory of claim 1 wherein the wearable device comprises a display connected to a band that extends over an ear of the user, and the extra-aural audio unit is mounted to the band.

11. A wearable device hearing accessory system comprising:
a hearing assembly comprising an attachment portion configured to attach to an extra-aural audio unit of a wearable device, a compliant guide portion configured to extend from the attachment portion to an ear of a user and transmit a sound wave to the ear, and a sensor operable to detect a mode of the wearable device; and
one or more processors communicatively coupled to the wearable device and operable to tune the sound wave based on the mode of the wearable device.

12. The system of claim 11 wherein the hearing assembly comprises a passive hearing assembly that passively guides the sound wave through the compliant guide portion to the ear.

13. The system of claim 11 wherein the hearing assembly comprises an active hearing assembly that electrically transmits an audio signal to a speaker coupled to an end of the compliant guide portion positioned in the ear.

14. The system of claim 11 wherein the mode of the wearable device detected by the sensor is an accessory mode in which the hearing assembly is attached to the wearable device.

15. The system of claim 14 wherein in the accessory mode, the sound wave is tuned to compensate for a characteristic of the compliant guide portion.

16. The system of claim 15 wherein the characteristic of the compliant guide portion is a length of the compliant guide portion.

17. The system of claim 14 wherein in the accessory mode, a second output port from a back volume chamber of the extra-aural audio unit is closed.

18. The system of claim 14 wherein a microphone is coupled to an end of the compliant guide portion positioned near the ear of the user, and the one or more processors are further operable to activate an active noise cancellation function based on detection of a noise near the ear.

19. The system of claim 11 wherein the mode of the wearable device detected by the sensor is a non-accessory mode in which the hearing assembly is detached from the wearable device.

20. The system of claim 19 wherein in the non-accessory mode, the sound wave is tuned to optimize transmission of the sound wave through open air to the ear.
